(19) United States
(12) Patent Application Publication
(10) Pub. No.: US 2009/0317201 A1
(43) Pub. Date: Dec. 24, 2009

(54) Drill of hexagonal cylinder

(76) Inventors: Chong Kuk Yi, Seoul (KR); In Cheol Cha, Incheon (KR)

Correspondence Address: DILWORTH & BARRESE, LLP, 1000 WOODBURY ROAD, SUITE 405, WOODBURY, NY, 11797, US

(21) Appl. No.: 11/990,801

(22) PCT Filed: Jan. 27, 2006
(86) PCT No.: PCT/KR2006/000318

§ 371 Date: Mar. 9, 2009

(30) Foreign Application Priority Data
Aug. 23, 2005 (KR) 20-2005-0024262

(51) Int. Cl. B27G 15/00

(52) U.S. Cl. 408/226

(57) ABSTRACT

The present invention relates to a drill of hexagonal cylinder. In a drill of diameter range 5 mm to 13 mm as using to make a hole on a metal, wood, or etc., a drill edge part in which is located at the bottom of the drill as formed a shape of screw to be able to make a hole the metal or wood, and a bit part in which is located at the top of the drill edge part as formed a shape of the teeth of a comb in the surface of a hexagonal cylinder to be able to separate and combine the drill in a drill tight.

### TECHNICAL FIELD

The present invention relates to a drill of hexagonal cylinder. In a drill of diameter range 5 mm to 13 mm as using to make a hole on a metal, wood, or etc., a drill edge part in which is located at the bottom of the drill as formed a shape of screw to be able to make a hole the metal or wood, and a bit part in which is located at the top of the drill edge part as formed a shape of the teeth of a comb in the surface of a hexagonal cylinder to be able to separate and combine the drill in a drill tight.

### BACKGROUND ART

The present invention relates to a drill to be able to make a hole on a metal, wood, or etc., using by the drill having a driving force of a motor. In more details, the present invention relates to a drill of hexagonal cylinder in which is a drill of diameter range 5 mm to 13 mm for preventing to run idle the drill in a drill tight by rotation when it is operating with combining the drill tight in the drill.

### DISCLOSURE OF INVENTION

### Technical Problem

Generally, a drill was not only used in various parts of manufacturing industries but also our lives as formed to be able to make a hole with rotating the drill as combining the drill and a drill tight, and the drill was coming out with various sizes and shapes according to its various purpose and uses. The problem of the drill in the prior art will become better understand with reference to accompanying drawings FIG. 1 as follows:

FIG. 1 is a perspective view showing a drill according to the prior art.

The FIG. 1 of the prior art related to a drill (100) of diameter range 5 mm to 13 mm, which is consisting of the drill (100) a drill edge (110) to be able to make a hole on a metal, wood, or etc., and a bit part (120) of a circle cylinder type to be able to combine the drill (100) in a drill tight. The problem is that the drill (100) was difficult to fix the drill (100) with accuracy in a drill tight because the bit part (120) was formed as a shape of circle cylinder, and the overload of a drill machine was happened, and the abrasion between the bit part (120) of the drill (100) and a drill tight was happened due to a running idle between rotating drill (100) and a drill tight

### Technical Solution

An object of the present invention for overcoming the above-mentioned problems is to provide a drill of hexagonal cylinder to be able to prevent the abrasion of a drill bit part and a drill tight when the drill is working, and to be able to prevent shaking of the drill because it can combine precisely and simply for combining the drill and drill tight as formed a shape of the teeth of a comb to both directions of each surface of the hexagonal cylinder in a drill bit part in which is located at the top part of the drill as a diameter range of 5 mm to 13 mm.

### Advantageous Effects

The above-mentioned present invention has effects to extend the life of a drill machine as prevention the overload of the drill machine, can be able to improve productivity because the processing time is short as preventing the abrasion of a rotating drill bit part and drill tight in drilling, and can be able to prevent shaking of the drill because it can combine precisely and simply in combining of the drill bit part and drill tight as formed a shape of the teeth of a comb to both directions on six surfaces of the hexagonal cylinder in a drill bit part in which is located at the top part of the drill as a diameter range of 5 mm to 13 mm.

### BRIEF DESCRIPTION OF THE DRAWINGS

The present invention will become better understand with reference to accompanying drawings which are given only by way of illustration and thus are not limitative of the present invention, wherein;

FIG. is a perspective view showing a drill according to the prior art.

FIG. 2 is a perspective view showing a drill of hexagonal cylinder according to the present invention.

### BEST MODE FOR CARRYING OUT THE INVENTION

In a diameter range 5 mm to 13 mm drill for drilling metal and wood of the present invention, comprising:

a drill edge part as formed a shape of screw to be able to make a hole the metal and wood, in which is located at the top part of the drill;

a drill bit part as formed a shape of the teeth of a comb in surfaces of a hexagonal cylinder to be able to separate and combine the drill in drill tight, in which is located at the top part of the drill edge part.

Moreover, the drill bit part comprises as formed a shape of the teeth of a comb to both directions on six surfaces of the hexagonal cylinder.

### Mode for the Invention

Referring now to the drawings wherein the showings are for purposes of illustrating a preferred embodiment of the invention only.

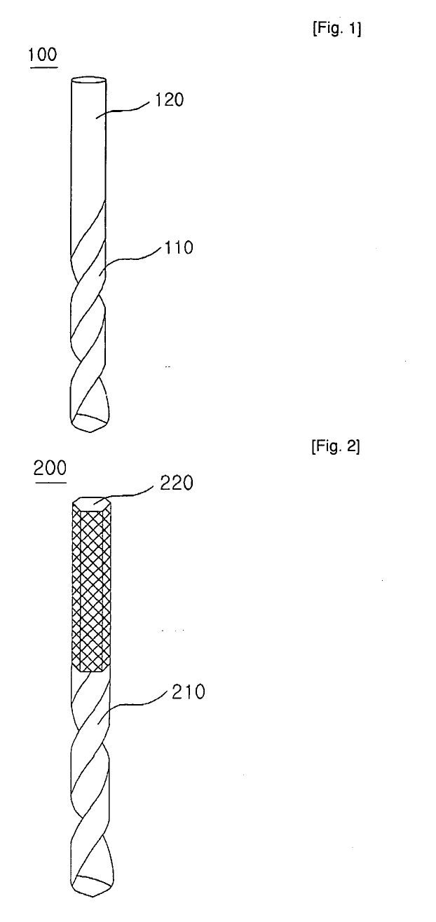

FIG. 2 is a perspective view showing a drill of hexagonal cylinder according to the present invention.

In a drill (200) of a diameter range 5 mm to 13 mm, the FIG. 2 comprise a drill edge part (210) to be able to make a hole for metals and woods, and a drill bit part (220) as formed combining the drill (210) and drill tight. The drill bit part (220) is as formed a shape of hexagonal cylinder, and is able to prevent a shaking of the drill (200) as combining precisely by formed a shape of the teeth of a comb to both directions on six surfaces of the hexagonal cylinder when the drill (200) and a drill tight are combined, and id able to abrasion of the bit part (220) of the drill (200) and the drill tight because the drill (200) and the drill tight is prevented when the drill (200) is rotating.

The present invention is not limited to the above embodiment. As the present invention may be embodied in several forms without departing from the spirit or essential characteristics thereof, it should also be understood that the above-described examples are not limited by any of the details of the foregoing description, unless otherwise specified, but rather should be constructed broadly within its spirit and scope as defined in the appended claims, and therefore all changes and modifications that fall within the meets and bounds of the claims, or equivalences of such meets and bounds are therefore intended to be embraced by the appended claims.

1. In a diameter range 5 mm to 13 mm drill for drilling metal and wood, a drill of hexagonal cylinder comprising:
a drill edge part in which is formed as a shape of screw to be able to make a hole metal and wood to a top part of the drill;
a drill bit part in which is formed as a shape of the teeth of a comb in surfaces of
a hexagonal cylinder to be able to separate and combine the drill in drill tight to a top part of the drill edge part.

2. As in claim 1, wherein said drill bit part in which is formed a shape of the teeth of a comb to both directions on six surfaces of the hexagonal cylinder.
